(19) United States
(12) Patent Application Publication
(10) Pub. No.: US 2006/0168114 A1
(43) Pub. Date: Jul. 27, 2006

(54) Audio processing system

(76) Inventors: Arnaud Glatron, Santa Clara, CA (US); Venkatesh Tumatikrishnan, Fremont, CA (US); Remy Zimmermann, Belmont, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/097,446

(22) Filed: Mar. 31, 2005

Related U.S. Application Data
(60) Provisional application No. 60/627,054, filed on Nov. 12, 2004.

(51) Int. Cl. G06F 15/16; G06F 15/177

(52) U.S. Cl. 709/218; 709/221; 709/228

(57) ABSTRACT

A single universal audio processing system intelligently and transparently processes audio streams in real-time. The system receives audio input from one or more sources, determines how the streams should be processed, and automatically processes them in real-time for delivery to an output system. The processing happens without any intervention from the output system, which is oblivious to this processing. A set of audio processing algorithms to accomplish acoustic echo cancellation (AEC), resampling, format conversion, channel mixing or any other desired audio processing function can be supported by a universal processing system, providing a universal solution to audio processing regardless of source or sink. In one embodiment, processing functionality is implemented in an upper filter driver created using a “framework” or software architecture that implements a conventional WDM filter and a dedicated environment for audio processing.

### CROSS REFERENCE TO RELATED APPLICATIONS

This application claims the benefit of U.S. provisional application 60/627,054 entitled “Transparent Audio Processing,” and filed Nov. 12, 2004, which is hereby incorporated by reference in its entirety; this application is related to U.S. patent application entitled “System and Method to Create Synchronized Environment for Audio Streams,” filed Mar. 31, 2005, attorney docket number 19414-10267.

### BACKGROUND

1. Field of the Invention

The present invention relates in general to digital audio processing, and specifically to a universal digital audio processing system for intelligently and transparently processing audio streams in real-time.

2. Background of Invention

Audio and recording environments are commonly rich in unwanted sounds and noises. Depending on the environment, any of a variety of sources of noise captured by a microphone—from phones, fans, or background conversations, for instance—may need to be filtered out of an audio stream. If there are multiple streams, these streams additionally must be consolidated for purposes of processing. Other processing such as echo cancellation, smoothing, and/or other enhancements may also be performed before the audio stream is provided to the end-user, through a speaker or other system.

Conventional audio processing systems are not capable of automatically and transparently performing the appropriate processing functions that may be required by an audio stream or streams. Existing systems are largely non-transparent, requiring downstream applications to be configured in order to take advantage of audio processing capabilities. In order to implement audio echo cancellation (AEC), for instance, it is commonly the case that a processing component must be integrated into the sound system and the output elected by a downstream application. Or, a third-party component must be used to proactively add the processed output to the system stream. The process of deciding what adjustments are needed and thereafter carrying them out is similarly not automated. Rather, such processes often require the intervention of an audio engineer or other human being. What is needed is a universal system that is capable of accepting different audio files or streams, autonomously determining processing requirements, carrying out the processing, and providing the processed audio to a user transparently and in real-time.

### SUMMARY OF THE INVENTION

An audio processing system and method processes audio streams in real-time. The systems and methods of this disclosure operate transparently, for example, without any intervention from or involvement of the producer of the audio stream or downstream application. With such a transparent solution audio streams can be processed without any help from the consumer/produced application, either individually or together, including in between audio devices.

This allows the creation of a large number of audio effects and/or improvements to the benefit of the end-user. In one embodiment, the system is implemented as a software driver upper filter that can be easily updated to reflect, for instance, new input or output devices, or improved to incorporate new processing logic as it is developed. In another embodiment, the system is configured to operate with a plurality of input and output devices, and relies on shared and customized processing logic depending on the input and output.

In an embodiment, an audio processing system is located on an audio data pathway between an audio source or sink and a client application, and is capable of performing real-time, transparent processing of a plurality of audio streams of a plurality of different audio formats. The system includes an input interface for receiving a plurality of audio streams of a plurality of different audio formats, and an arbitration and control module for determining the format of each of the plurality of audio streams, and, responsive to each format, configuring the audio processing system. It also includes at least one processing node coupled to the input interface and configured by the arbitration and control module for automatically processing each of the plurality of audio streams, as well as an output interface for outputting each processed audio stream to the client application.

In another embodiment, a method for transparently processing a plurality of audio streams of different formats is provided. The method involves receiving from a source a first audio stream of a first audio format and receiving from a source a second audio stream of a second audio format. Responsive to the audio format of the first audio stream, one or more processing functions is called from a library of a plurality of processing function libraries to process the first audio stream and output a processed first audio stream to a first audio sink. Likewise, responsive to the audio format of the second audio stream, one or more processing functions is called from a library of the plurality of processing function libraries to process the second audio stream and output a processed second audio stream to a second audio sink.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE INVENTION

The invention has other advantages and features which will be more readily apparent from the following detailed description of the invention and the appended claims, when taken in conjunction with the accompanying drawings, in which:

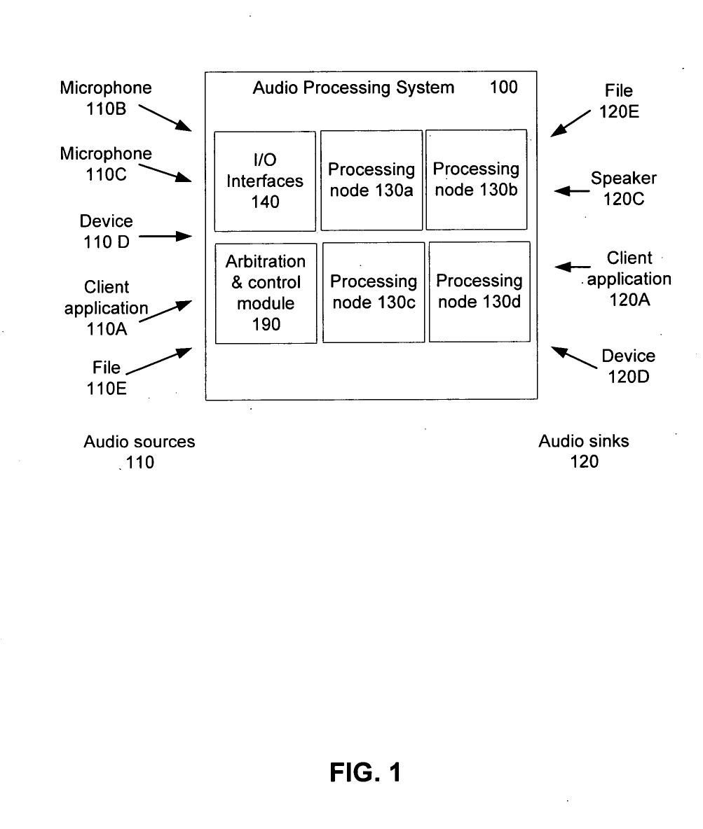

FIG. 1 depicts a functional representation of an audio processing system in accordance with an embodiment of the invention.

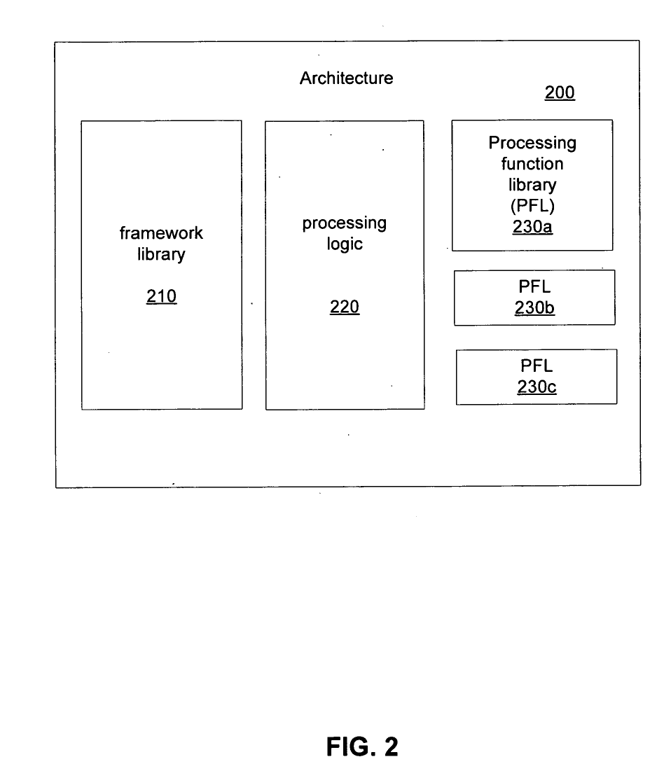

FIG. 2 depicts a diagram of an audio processing architecture implemented in a Windows Driver Model (WDM) Environment in accordance with an embodiment of the invention.

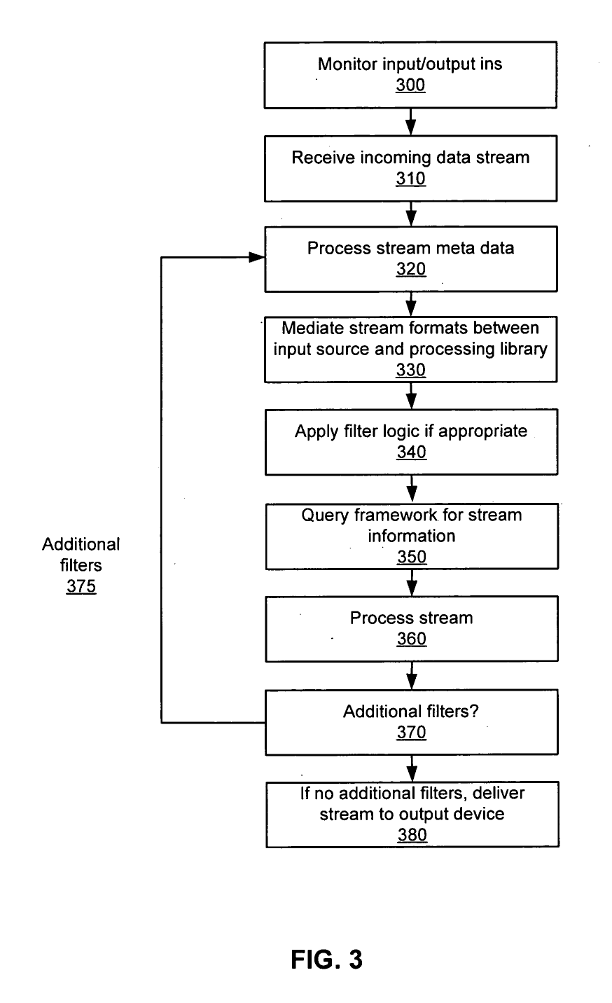

FIG. 3 is a flowchart depicting the steps used to process an audio stream using a transparent audio processing system according to an embodiment of the invention.

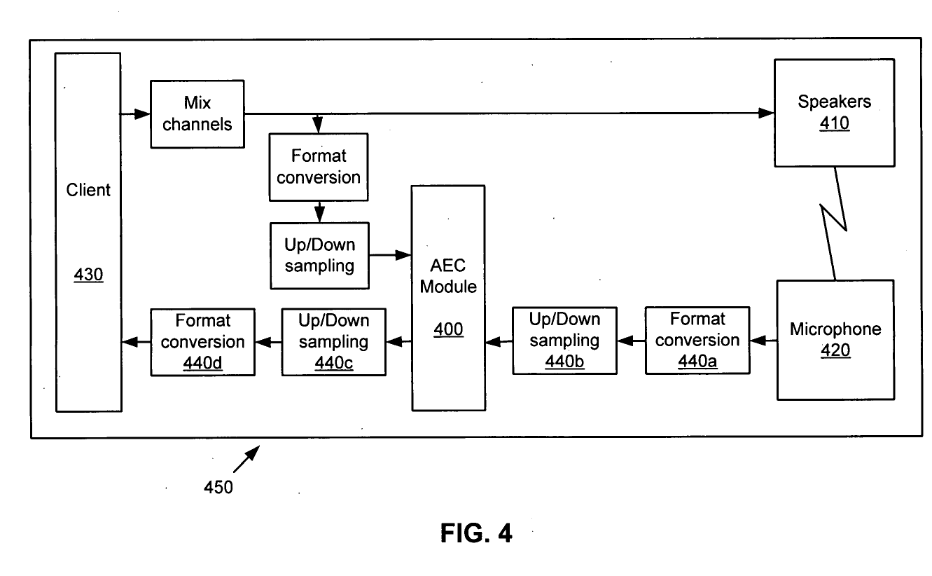

FIG. 4 is a block diagram depicting the flow of an audio stream through an audio echo cancellation processing node in accordance with an embodiment of the invention.

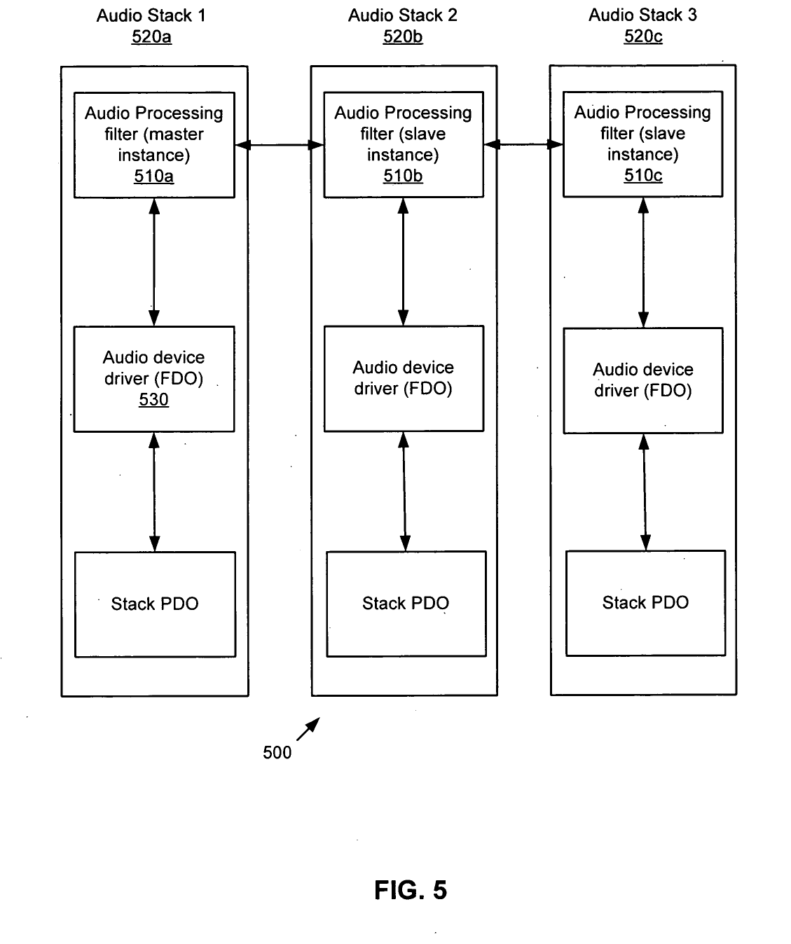

FIG. 5 depicts a configuration of audio processing filters installed on audio stacks in accordance with an embodiment of the invention.

### DETAILED DESCRIPTION OF THE INVENTION

Reference will now be made in detail to several embodiments of the present invention. Although reference will be made primarily to implementation of a transparent audio processing system in a Windows Driver Model (WDM) environment, one of skill in the art knows that the same concepts can be implemented in any of a variety of operating environments including a Linux, Mac OS, or other proprietary or open operating system platform including real-time operating systems.

FIG. 1 depicts a functional representation of an audio processing system 100 in accordance with an embodiment of the invention. The system 100 can accept an audio stream or streams from one or more sources 110, process the stream or streams, and output the result to a client application 120A. Likewise, the system 100 may be positioned between an audio sink 120 and a client application 110A and process audio streams therebetween.

The audio stream may be sourced from various sources 110 including peripheral devices such as stand-alone or other microphones 110B,110C, microphones 110B,110C embedded in video cameras, audio sensors, and/or other audio capture devices 110D, 120D. It may be provided by a client application 110A or converter. The audio stream can comprise a file 110E, 120E, and be provided from a portable storage medium such as a tape, disk, flash memory, or smart drive, CD-ROM, DVD, or other magnetic, optical, temporary computer, or semiconductor memory, and received over an analog 8 or 16 pin port or a parallel, USB, serial, or SCSI port. Or, it may be provided over a wireless connection by a Bluetooth™/IR receiver or various input/output interfaces provided on a standard or customized computer. The audio stream may also be provided from an audio sink 120, such as a file 120E, speaker 120C, client application 120A or device 120D. The client application 120A can be any consumer that is a client to the source/sink 110, 120. This could include a playback/recording application such as Windows media player, a communications application such as Windows messenger, an audio editing application, or any other audio or other type of general or special purpose application.

The audio stream may be in any of a variety of formats including PCM or non-PCM format, compressed or uncompressed format, mono, stereo or multi-channel format, or 8-bit, 16-bit, or 24+ bit with a given set of sample rates. It may be provided in analog form and pass through an analog to digital converter and may be stored on magnetic media or any other digital media storage, or can comprise digital signals that can be expressed in any of a variety of formats including .mp3, .wav, magnetic tape, digital audio tape, various MPEG formats (e.g., MPEG 1, MPEG 2, MPEG 4, MPEG 7, etc.), WMF (Windows Media Format), RM (Real Media), Quicktime, Shockwave and others.

Positioned between the audio source 110 or audio sink 120 and client application 110A, 120A, the audio processing system 110 comprises a set of input/output interfaces 140, an arbitration and control module 150, and a set of processing nodes 130. The audio processing system 100 is configured to transparently process the audio streams. As one of skill in the art will know, this allows the client application 110A, 120A to remain unaware of the original format of audio streams from the audio source 110 or audio sink 120, the system 100 accepts a variety of formats and processes it according to the needs of the client application 110A, 120A.

The audio processing system 100 is configured to receive one or more audio streams through a plurality of interfaces 140, each adapted for use with an input source 110, 120. One or more interfaces 140 may follow a typical communications protocol such as an IRP (I/O Request Packet) Windows kernel protocol, or comprise a COM (Component Object Model) or other existing or custom interface. The received streams are routed through pins that specify the direction of the stream and the range of data formats compatible with the pin. The audio processing system 100 monitors input pins that match in communication type and category the audio formats it supports.

The audio processing system 100 also includes an arbitration and control module 150. As used herein, the term “module” can refer to computer program logic for providing the specified functionality. A module can be implemented in hardware, firmware, and/or software. This module 150 determines the format of each stream and uses that information to determine how to configure the audio processing system. For instance, the module 150 may determine that an incoming stream is of a certain format, but that it needs to be converted into another format in order to carry out the desired processing. The audio processing system 100 will therefore route the audio stream through the appropriate processing nodes 130 to accomplish the required processing while potentially avoiding other nodes. Similarly, the arbitration and control module 150 may be aware of the requirements of the client application 110A, 120A and use those to drive configuration of the processing system 100 to ensure that the incoming stream is transformed to meet these requirements, effectively mediating between the source 110 or sink 120 and application 110A, 120A. This mediation process may involve communicating with both the source 110 or sink 120 and the application 110A, 120A, to determine a processing solution compatible with both. The audio processing stream may also implement processing in accordance with system requirements, including what formats the system 100 is designed to be used with. It may set up the processing system 100 to maximize processing or memory resource efficiency, for instance.

In an embodiment, several channels of audio data are consolidated before being provided to the audio processing system 100. In another embodiment, the audio processing system 100 is capable of processing either single or multiple audio data streams simultaneously. Various non-synchronized streams that pertain to different audio devices 110D, 120D may be synchronized using any of a variety of mechanisms including one or mechanisms described in Appendix B of the U.S. provisional application entitled “Transparent Audio Processing,” filed Nov. 12, 2004 and referenced above. The system 100 has several inputs connected to various peripheral devices 110D, 120D and other sources, and decides how to process the audio stream in part depending on the source 110 and the output client application 120A, 110B. In alternate embodiments, the audio streams can be processed in parallel, meaning for instance that they are processed at the same time using two processors. Or the processing may occur in an interleaved fashion on a processor, wherein two streams are alternatively processed in time. Or, the processing may take place asynchronously.

The audio streams are received by the audio processing system 100 and are digitally processed by one or more processing nodes 130 as they flow along data paths to be provided to the client application 110A, 120A. Through these processing nodes 130, the stream may be exposed to one or more processing components capable of performing various processes including: rendering, synthesis, adding reverb, volume control, acoustic echo cancellation (AEC), resampling, format conversion, bit forming, noise suppression, and channel mixing.

In an embodiment of the system shown in FIG. 1, the system is implemented through a series of WDM upper filter drivers (also referred to as “filter” throughout this disclosure) that are on each of the driver stacks supported by the audio processing system. Each filter can be configured to monitor input pins, output pins or no pins in one direction or in both pin directions. The driver inserts itself on top of the function device drivers for the audio devices from/to which the streams are coming or going. Each of the filter drivers implements a separate independent audio processing function. To apply multiple audio processing functions to a given stream, the appropriate filter drivers need to be inserted on the targeted device stack(s). The filter can be inserted onto a stack automatically through plug'n play (PNP), or may put itself there manually if it detects for instance that another instance of the filter is necessary on a given stack. As described below with reference to FIG. 5, where there are multiple stacks, there are several methods available for installing the filters on the stacks.

Depending on the number of devices and input sources supported by the processing system 100, there may be a plurality of stacks. Among these, for each filter driver, there is a single master stack; the remaining stacks are considered slave stacks. The master stack will be flagged in the INF file. The master stack is treated differently by the processing logic depending on the processing needs of the system. In one embodiment, each data packet serially goes through all the available filters one at a time. As the order of the stream operations (i.e.: the order in which the filters are called) cannot be guaranteed, filters configured serially must not rely on another operation to be completed ahead of it. If such a dependency is needed then these two filters can be combined in one single filter. In another embodiment, there are a great number of possible filters and more general logic external to the filters is used to determine the pathway of a stream depending on the characteristics of the stream.

FIG. 5 depicts a configuration 500 of audio processing filters 510 installed on audio stacks 520 in accordance with an embodiment of the invention. To apply multiple audio processing functions to a given stream, the appropriate filter drivers 510 need to be inserted on the targeted audio devices. In a Windows Media Driver environment, several methods can be used to configure multiple stacks with the appropriate filters. Using one technique, all instances of the filter can be loaded through PNP. According to a PNP protocol, a request for each master 520a and slave stack 520b, 520c is provided to a filter 510. Each filter 510 that loads will thus automatically be associated with the master or a slave stack 510. If it is the master stack, then it will check whether or not it needs to load any slaves.

In another implementation in a Windows Media Driver environment, filter installation onto the stacks 520 shown in FIG. 5 is implemented over several steps. A master instance 520a of the filer is installed using PNP. The master filter instance 520a verifies that there is no no-load flag on the stack, in order to avoid the addition of multiple filters to a given stack. If the stack 520 is a master stack 520a set to load, it will proceed to see if it needs to load slaves 520c. To locate potential targets for a new instance of the filter, several steps are undertaken. First, all WDM interfaces in the system are located, and then all stacks that are marked as no load are eliminated. The list of targets is further narrowed to exclude stacks that already have the filter, to ensure that only one instance of the filter is installed on a given stack. This is accomplished by maintaining a list of all of the physical device objects (PDOs) at the root of all the stacks on which a given filter has added itself. After that the master instance 510a will create another device object, a functional device object (FDO) 530a and link it on top of the target stack 520 as shown in FIG. 5.

FIG. 2 depicts a diagram of an audio processing architecture 200 implemented in a Windows Driver Model (WDM) Environment in accordance with an embodiment of the invention. Each of the processing nodes of FIG. 1 implements a separate independent audio processing function. This may be accomplished, for instance using audio processing architecture 200 of FIG. 2. The architecture 200 (alternatively referred to as an “architecture driver”), includes an instance of a framework library 210, processing logic 220, and processing function libraries 230.

A “framework library” 210 (also referred to herein as “framework”) is a static library that is logically linked to the audio processing logic 220 and contains core code that is commonly used in a WDM environment by all architecture instances. The framework 210 has a set of standard components for use with the all instances of the architecture 200 and each implementation of the architecture 200 has a set of standard callbacks to these shared components. Each architecture 200 also includes components that are instantiated for each instance of the architecture 200 that can be thought of as “instantiated components.” These components are specific to the dedicated environment for audio processing and vary across architecture instances 200.

This configuration allows each new architecture driver 200 to use the same framework and only need to configure a handful of tables and variables. The framework library 210 has a variety of active roles in which it directly affects the behavior of the stack on which it is loaded. Second it has semi-passive roles, where it intercepts some of the requests going through the stack and routes these requests through the architecture logic in order to achieve the desired audio processing. Finally it also has fully passive roles where it exposes an application programming interface (API) for use directly by the architecture logic, to enable the architecture logic to interact with the audio streams' environment. The API specifies data formats for specific channels and pins, and specifies various channel state, variable management, and related methods. Exemplary methods relate to channel management such as getting and setting a channel format and acquiring and releasing a channel, and getting and setting channel state. Other exemplary methods relate to format management, for instance returning an audio format required for a given channel, or processing functions that use shared and instantiated variables.

In addition to the framework core 210, each architecture 200 provides processing logic 220 to interact with the framework library 210. The processing logic 220 contains logic for carrying out various processing functions such as facilitation of architecture initialization, closing of processing function libraries when the architecture from the master stack unloads, acting upon certain events, the data processing itself, and a variety of others. These functions may be implemented through a set of callbacks. The processing logic 220 includes a passive layer that includes format tables and related information, and an active layer that supports intelligent decision-making by the architecture 200. The processing logic 220 also includes various allocator components for allocating memory buffers to process data from data streams. The processing logic 220 logically connects the framework library 210 to the function libraries 230. It contains code to invoke the framework library 210 and respond to the calls of the framework library 210. In response to such a call, the logic 220 can invoke audio processing algorithms of a function library 230 to process an audio stream. Such processing is carried out in accordance with the format of the audio stream.

Finally, the actual audio processing algorithms such as AEC, resampling, format conversion, channel mixing, and others are implemented in the processing function libraries 230 that can then be linked as needed to the various projects that require them. Standard components that are included in the architecture logic 200 use these libraries to process the audio data streams. In an embodiment, standard components are implemented in a library 230 that exposes the implementation of a public class. In addition, a C-style interface is defined to allow 3^{rd} parties to develop components for proprietary processing frameworks. Each 3^{rd} party component is wrapped in a class implementation, enabling the 3^{rd} party implementations to be independent from the platform on which they will run. Exemplary functions provided by the processing function libraries 230 could include basic resampling, channel mix, format conversion, silence buffer, drift correction, audio echo cancellation, bit forming, noise suppression, beam forming, waveform correlation, noise cancellation and notch filtering. A user can enter his or her preferences for the types of processing to be performed on various types of streams, through a graphical user or other interface. Various processing instructions may be provided, to address different types of audio stream inputs.

In an embodiment, a framework library 210 is capable of tracking multiple concurrent streams, and routing the streams to the appropriate processing logic 220, depending on the input or output format or other characteristics of the audio stream, source, or output. For example, in one embodiment, when a new stream is introduced to a framework library 210, the processing logic 220 uses code in the framework library to intercept the stream and acquire a virtual channel. If it cannot acquire the required channel, then that means that the framework is already busy and cannot handle that stream. When a stream is closed, its channel, if any, is freed so that it can be re-used by another stream. The channels may be uni-directional and associated with corresponding pins. The pins are monitored using callbacks including close, set format, buffer received and stream state change.

In another embodiment, an audio processing system is configured to simultaneously process two audio streams of different audio formats, for instance an 8-bit sample stream and a 16-bit sample stream. To accomplish processing, for instance audio echo cancellation, on the streams, the system tracks data and history about both streams or the streams' state. As known to one of skill in the art, the “state” of a stream comprises relevant information affecting or about a stream. This may include, for example, the current format of the stream (including the sampling rate, the number of bits per sample), the direction (in or out), whether or not the stream is running (stopped, paused, run), the number of data samples that went by on that stream, and/or drift related information. It may also comprise information related to or specific to the implementation—for example in a WDM the state of stream may reflect one or more of device or file object, KS pin, KS architecture categories, IRP source vs. IRP sink, and/or DirectSound On or Off. The state information relevant for processing may vary depending on the application. In an embodiment, for example, noise suppression and echo cancellation processing rely on statistical characteristics of the previous data samples in the stream, and therefore use this “state” information to carry out processing. Two or more streams may also share a state or in other words have a shared state. This can take place when some or all of the state information of one stream is accessible by both streams. Relevant processing logic can thus use the information of both streams when processing data from one of the streams. Alternatively, it may mean that there is only one copy of all or some of the state information for both streams, and this shared state information is used in processing. For example, a typical way of doing audio echo cancellation on two streams that do not have a shared state requires that the processing logic take into account the format of both streams when configuring the data path and then use statistical information collected on both streams when it process the near-end stream in order to correctly remove the echo. When the streams have a shared state, however, the system applies shared processing logic to the streams, for instance using the shared or global portions of the framework.

FIG. 3 is a flowchart depicting the steps used to process audio streams using a audio processing system according to an embodiment of the invention. The streams flow into the system, pass through a series of filters for processing, and exit the audio system.

The audio processing system monitors 300 various input/output pins coupled to the audio processing system. In an embodiment, a certain set of events are monitored and their occurrence triggers execution of a callback to the filter logic of a framework so that the logic can process the information associated with the events accordingly with the targeted functionality. The pin events that are monitored are: open, close, set format, buffer received, stream position enquiry and stream state change. Various different streams from different sources flow through the pins and reach/exit the audio processing system. As the audio processing system receives 310 an incoming data stream, it processes 320 meta data about the stream including its format. This allows the framework to forward the stream with its meta data to the filter logic even if the meta data is not encapsulated in each stream packet. This also enables the framework to mediate 330 stream formats including data rate, and other requirements between the input/output devices/systems and the internal processing libraries to ensure that the format and other requirements are compatible across all the components, in order to economize on processing resources and minimize quality degradations caused by unnecessary format transformations. The mediation may be accomplished by any of a number of ways including restricting the format of the data stream by filtering the data ranges exposed by the underlying hardware, modifying the results of the data intersections, and/or intercepting and enforcing a standardized formats in calls during the creation of pins. This step does not require any intervention by the input/output devices/systems. This process is possible because the requirements for the processing modules are embedded in the static layer of the filter logic.

A data stream is received by the first filter on its data or audio stream path. The framework portion of that filter examines the stream metadata and decides whether or not it needs to be processed by the filter logic. The decision is based mostly on the static layer of the filter logic, but also on the state of the stream and potentially on a set of callbacks executed in the filter logic to let it alter the automatic behavior of the framework. If the stream does not need to be processed by that filter at this time, then the stream is forwarded to the next filter in the chain. If this was the last filter then the stream exits the audio processing system. If, on the other hand, the stream needs to be processed by the filter, the stream is forwarded for application 340 of the filter logic to the stream. The filter logic can query 350 the framework for any stream information it may need (meta data, state etc.). The filter logic will call necessary processing function libraries as needed in the appropriate order to process 360 the stream. If needed the filter logic implements additional logic to make the stream compatible with the next library. For example if the stream needs to be synchronized with another stream, the appropriate drift correction is applied before calling the next library. When this is done, the stream leaves the filter and determines 370 whether there are additional filters. If there are additional filters 375 in the chain, stream meta data is processed 320 once again to determine whether or not the filter logic should be applied 340. If this was the last filter 380 then the stream exits the audio processing system. The processed audio stream is then delivered 380 to one or more of the output system described above.

Now, reference will be made in particular to the implementation of an exemplary audio echo cancellation processing node. FIG. 4 is a block diagram depicting the flow of an audio stream through an audio echo cancellation processing node 450 in accordance with an embodiment of the invention. An AEC module 400 is positioned between a microphone 420 and client application 430 and between the client application 430 and output speakers 410. In an embodiment, two channels are provided for input and one for output. The component 450 cancels local echo between the output stream (i.e. the far end signal from the speakers 410) and the input stream (i.e. the near end signal from the microphone 420). The component could be designed using a C-Style interface or wrapped in a C++ class wrapper. In various embodiments, the AEC module 400 may be configured to optimize parameters like CPU efficiency or quality. The component supports PCM formats, mono, 8-bit, or 16-bit with a given set of sample rates for instance 16 kHz or 8 kHz.

The AEC module 400 may be adapted for use in various audio systems. Configurable parameters may include auto-off (AEC becomes completely inactive if the level of echo is small, and re-activates if the level of echo increases again), state machine control (controls how sensitive the state machine is to double talk), tail length control and comfort noise level. These parameters may be controlled through a user interface during the set up phrase of an audio system.

As shown in FIG. 4, an audio stream is generated by a microphone 420, and passes through various processing nodes before being provided to a client application that controls the audio stream. The audio stream is further processed before it is provided to output speakers. As shown, various processing modules 440 are provided to implement AEC, including up/down sampling, channel mix, format conversion, standard allocation, and drift correction. Optionally, a notch filter and waveform correlator are also provided. As shown, an audio stream passes through format conversion 440a and sampling 440b modules before being passed to the AEC module 400. In an embodiment, different audio streams from different sources with different formats may all be provided to the format conversion module, to be converted (or not converted) as needed.

Before the audio stream being processed is provided to the AEC module 400 it optionally may pass through additional processing by a waveform correlator and notch filter. A waveform correlator measures the delay between the far end and the near end signals in the context of an AEC implementation. Its main role is to allow for a precise value to be input into an AEC component. The waveform correlator may be implemented in any of a variety of ways known to one of skill in the art, however, preferably it performs iteratively, returning the new best guess delay value each time a new buffer is submitted on the near end, and provides a metric from 0 to 100 that indicates the degree of confidence (0 is none and 100 is total) of the delay measurement. A notch filter acts to reject a given frequency. Its can be used to flatten the frequency response of audio devices that behave unevenly at given frequencies. This flattening allows further audio processing and without creating other troublesome artifacts.

The AEC module 400 may be implemented in any of a variety of ways. In an embodiment, the callbacks provided in Table 1 are supported for processing.

TABLE 1
AEC Callbacks

| OnFilterLoad( ) | Initialize standard components on | | |
|---|---|---|---|
| | master load. | | |
| OnFilterUnload( ) | Close standard components on master | | |
| | unload. | | |
| OnDecidePinDirs( ) | If Master set PinDirs to OUT, if not | | |
| | Master set PinDirs to IN | | |
| OnGetRequiredFormat( ) | Look at current formats for channel | | |
| | 1 (in and out). Depending on the | | |
| | state of the PID_CPU_ALLOWANCE | | |
| | property, select AEC format that | | |
| | will require the correct CPU usage | | |
| | and give the required quality | | |
| | (i.e.: optimize the amount and types | | |
| | of required transforms). Return that | | |
| | format and configure AEC component | | |
| | with that format if it was not set | | |
| | to that format yet. | | |
| OnSetChannelState( ) | Not implemented. | | |
| OnSharedVariableChanged( ) | If the following variable is changed | | |
| | do the following: | | |
| | Process: remember the state of | | |
| | Process and set DSoundDisable to same | | |
| | state as Process. | | |
| OnKSProperty( ) | Handles the property set per its | | |
| | specification. If needed alters | | |
| | Framework state variables using | | |
| | Framework API. | | |
| OnOpen( ) | Acquire channel 1 for the | | |
| | corresponding direction. If fails | | |
| | return with channel set to −1. | | |
| | If succeeds return with channel set | | |
| | to 1 and call SetChannelFormat( ) | | |
| | to store the current format on | | |
| | channel 1 for the corresponding | | |
| | direction. | | |
| OnClose( ) | Release channel for the corresponding | | |
| | direction. | | |
| OnSetFormat( ) | Call SetChannelFormat( ) to store the | | |
| | current format on channel for the | | |
| | corresponding direction. | | |
| OnSetStreamState( ) | When transitioning to the run state | | |
| | use GetRequiredFunctionFormat( ) and | | |
| | GetChannelFormat( ) to figure out the | | |
| | proper set of transforms that will | | |
| | be needed (remember necessary | | |
| | transforms). Also initialize standard | | |
| | Allocators accordingly. When going | | |
| | to the pause or stop state: de- | | |
| | initialize the standard Allocators. | | |
| | Call SetChannelState( ) to set the | | |
| | state of the channel for the | | |
| | corresponding direction. | | |
| OnBuffer( ) | 1. | If Process is 0 then return and do | |
| | | nothing (not active). | |
| | 2. | Get state of channel 1 for in and | |
| | | out using GetChannelState( ). If | |
| | | the channel is not in the run | |
| | | state for both directions then | |
| | | return and do nothing as there | |
| | | is no need for AEC. | |
| | 3. | If direction is IN (playback): | |
| | | a. | Use the Channel Mix component |
| | | | to mix the channels if needed |
| | | | (do in-place). |
| | | b. | Store data in drift corrected |
| | | | Q1 queue and in Q2 queue, |
| | | c. | Get data from Q2 queue and |
| | | | return to framework. |
| | | If direction is OUT (record): | |
| | | a. | Store data in Q3 queue, |
| | | b. | Get data from Q4 queue and |
| | | | return to framework |

In addition to this callback, the
AEC function needs to create a thread
(the thread represented in green in
the representation above) to process
the data from Q1 to the AEC and from
Q3 to Q4 through the AEC using the
necessary allocators (and recycling
the buffers accordingly) and the
necessary data manipulation
components.

Upon reading this disclosure, those of skill in the art will appreciate still additional alternative structural and functional designs for a system and a process for synchronizing asynchronous audio streams for synchronous consumption by an audio module through the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

We claim:

1. An audio processing system located on an audio data pathway between an audio source or sink and a client application for performing real-time, transparent processing of a plurality of audio streams of a plurality of different audio formats, the system comprising:
an input interface for receiving a plurality of audio streams of a plurality of different audio formats;
an arbitration and control module for determining the format of each of the plurality of audio streams, and, responsive to each format, dynamically configuring the audio processing system without any intervention from the client application;
at least one processing node coupled to the input interface and configured by the arbitration and control module to automatically process each of the plurality of audio streams; and
an output interface for outputting each processed audio stream to the client application.

2. The system of claim 1 wherein the client application comprises one of an audio playback application, an audio recording application, an audio editing application, and a communications applications.

3. The system of claim 1, wherein the system is implemented in a Windows Driver Model (WDM) environment.

4. The system of claim 3, wherein each of the arbitration and control module and the at least one processing node are implemented in a WDM filter driver.

5. The system of claim 1, wherein the input interface is configured to receive an audio stream from at least one of: a peripheral device, a storage medium, and an audio processor.

6. The system of claim 1, wherein at least one of the input interface and the output interface is configured to implement at least one of a Windows protocol and a Component Object Model protocol.

7. The system of claim 6, wherein the Windows protocol comprises one of: an Input/Output request packet (IRP) protocol and a Windows kernel protocol.

8. The system of claim 1, wherein the system is configured to simultaneously process a first audio stream and a second audio stream, the first audio stream having a different format than the second audio stream.

9. The system of claim 8, wherein the first and second audio streams have a shared state, wherein the shared state comprises one of: a shared format, shared statistical information, and a shared direction, and the system is configured to apply shared processing logic to the first audio stream and the second audio stream responsive to the shared state of the streams.

10. The system of claim 1, wherein the input interface is configured to receive an audio stream according to a Windows protocol further comprising a second input interface configured to receive an audio stream according to a Component Object Model protocol.

11. The system of claim 1, wherein the at least one of processing node is configured to perform on an audio stream one selected from the group of: format conversion, automatic volume control, acoustic echo cancellation, noise suppression, beam forming, drift correction, and channel mixing.

12. The system of claim 1, wherein the output interface is configured to output a processed audio stream to one of: an audio rendering device, a storage medium, a network sink, and an audio processor.

13. The system of claim 1, wherein the arbitration and control module is adapted to configure the system responsive to at least one of: processing resources available to the system and a plurality of audio formats the system is adapted to process.

14. A method for transparently processing a plurality of audio streams of different formats, the method comprising the steps of:
receiving from a source a first audio stream of a first audio format;
receiving from a source a second audio stream of a second audio format, wherein the second audio format is different than the first audio format;
responsive to the audio format of the first audio stream, calling one or more processing functions from a library of a plurality of processing function libraries to process the first audio stream and outputting a processed first audio stream to a first audio sink; and

15. The method of claim 14, wherein the step of processing comprises one of: parallel processing, interleaved processing, and asynchronous processing of the first audio stream and the second audio stream.

16. The method of claim 14, further comprising:
receiving a processing instruction to configure the system; and
calling a processing function from the library of the plurality of processing function libraries to process the first audio stream responsive to the processing instruction.

17. The method of claim 16, further comprising:
calling a processing function from the library of the plurality of processing function libraries to process the second audio stream responsive to the processing instruction.

18. The method of claim 16, wherein the step of receiving comprises receiving the processing instruction through a user interface.

19. The method of claim 14, further comprising:
receiving a plurality of channels of an audio stream; and
consolidating the channels for processing as a single channel audio stream.

20. A transparent software audio processing architecture for processing a plurality of transparent software audio streams of a plurality of audio formats in a system comprising a plurality of such audio processing architectures, the architecture comprising:
a plurality of function libraries, each library comprising a plurality of audio processing algorithms for at least one of the plurality of audio formats;
an instance of a framework library for use by the plurality of audio processing architectures, the framework library comprising code for intercepting the plurality of audio streams for the purpose of processing by one or more of the plurality of the function libraries and a plurality of audio stream calls; and
processing logic logically coupling the framework library to the plurality of function libraries, the logic configured to:
invoke the instance of the framework library; and
invoke one or more of the audio processing algorithms of at least one of the plurality of function libraries to process an audio stream responsive to the format of the audio stream and a call from the framework library.

21. The architecture of claim 20, wherein a function library of the plurality of function libraries comprises an algorithm for performing at least one of: acoustic echo cancellation, resampling, format conversion, channel mixing, buffering, drift correction, beam forming, waveform correlation, noise cancellation, and notch filtering.

22. The architecture of claim 20, wherein the processing logic includes a static layer comprising audio format conversion data used by the framework library to configure its handling of each of the plurality of audio streams responsive to the processing logic and a dynamic layer for supporting processing by the architecture responsive to the format of an audio stream.

23. The architecture of claim 20, wherein the architecture is implemented according to the Windows Driver Model (WDM) and is automatically installed through a WDM method on an audio device driver stack associated with one of: an audio source and an audio sink.
